(19) United States
(12) Patent Application Publication
(10) Pub. No.: US 2003/0227785 A1
(43) Pub. Date: Dec. 11, 2003

(54) On-line uninterruptible power supplies with two-relay bypass circuit and methods of operation thereof

(76) Inventor: Robert W. Johnson JR., Raleigh, NC (US)

Correspondence Address: MYERS BIGEL SIBLEY & SAJOVEC, PO BOX 37428, RALEIGH, NC, 27627, US

(21) Appl. No.: 10/164,471

(22) Filed: Jun. 6, 2002

(51) Int. Cl. H02M 5/45

(52) U.S. Cl. 363/37

(57) ABSTRACT

An on-line uninterruptible power supply (UPS) comprises an AC input configured to be coupled to an AC power source and an output configured to be coupled to a load. The UPS also includes an AC/AC converter circuit coupled to the AC input and operative to generate an AC voltage from the AC power source. A first mechanical relay (e.g., a single-pole single-throw (SPST) relay) is coupled between an output of the AC/AC converter circuit and the output. A second mechanical relay is coupled between the AC input and the output. The UPS further includes a control circuit operative to control the first and second mechanical relays to selectively place the UPS in an on-line mode in which the first mechanical relay couples the AC/AC converter circuit to the output and the second mechanical relay decouples the AC input from the output or a bypass mode in which the first mechanical relay decouples the AC/AC converter circuit from the output and the second mechanical relay couples the AC input to the output.

### BACKGROUND OF THE INVENTION

The present invention relates to power supply apparatus and methods of operation thereof, and more particular, to uninterruptible power supply (UPS) apparatus and methods.

Many conventional uninterruptible power supplies (UPSs) use an on-line topology. As shown in FIG. 1, a typical on-line series train UPS 10 includes an AC/AC converter circuit 12 that produces an AC output voltage at a load from an AC input voltage provided by an AC power source 20, such as a utility. As shown, the AC/AC converter circuit 12 may include a combination of a rectifier and an inverter, connected by a DC bus that can isolate the load 30 from disturbance and other degradation of the AC power source 20. Typically, the DC bus is also coupled to an auxiliary source of power, such as a battery, which maintains the DC voltage on the DC bus in the event the AC power source fails. Some on-line UPSs use circuit topologies other than a series train, including more complex topologies, such as delta converters, or other techniques.

Under normal operating conditions, on-line UPS's supply power to a load through a rectifier/inverter chain or similar regulating circuitry, providing relatively clean and regulated power at the output of the UPS. When the AC power source 20 fails, the UPS 10 may achieve an uninterrupted transition to battery power, as there typically is no need to change the state of a transfer switch. As illustrated in FIG. 1, the UPS 10 may also include a bypass feature such that if, for example, the AC/AC converter circuit 12 fails or becomes overloaded, the load 30 may be decoupled from the AC/AC converter circuit 12 (e.g., the output inverter) and coupled directly to the AC source 20 by a form C (double-pole double-throw) relay 14. Such a feature may also be used to provide an “economy” mode of operation, as power dissipation associated with the operation of the rectifier/inverter chain may be reduced when the load is transferred to the bypass path.

Many conventional low-cost UPSs use a “break before make” technique to transfer between normal and bypass modes, i.e., they produce a disruption in the output voltage as the form C relay 14 transitions between states. However, some units, as shown in FIG. 1, use a solid state switch 16, e.g., anti-parallel connected silicon controlled rectifiers (SCRs), to smooth transfer of the load 30 to and from the AC source 20 until the form C relay 14 has transitioned. In particular, when transfer of the load 30 from the AC/AC converter circuit 12 to the AC source 20 is initiated, the solid state switch 16 may be turned on immediately preceding triggering of the relay 14. Because the solid state switch 16 can begin conducting nearly instantaneously, the AC source 20 can be connected to the load 30 via the solid state switch 16 while the contacts of the relay 14 move between positions. Similarly, when a transfer of the load 30 back to the AC/AC converter circuit 12 is initiated, the solid state switch 16 may be turned on immediately preceding triggering of the relay 14, and may be maintained in an “on” state until the contacts of the relay 14 have switched over to the AC/AC converter circuit 12. The solid state switch 16 may then be turned off to break the direct connection between the AC power source 20 and the load 30.

### SUMMARY OF THE INVENTION

According to some embodiments of the invention, an on-line uninterruptible power supply (UPS) comprises an AC input configured to be coupled to an AC power source and an output configured to be coupled to a load. The UPS includes an AC/AC converter circuit coupled to the AC input and operative to generate an AC voltage from the AC power source. A first mechanical relay (e.g., a single-pole single-throw (SPST) relay) is coupled between the AC/AC converter circuit and the output. A second mechanical relay (e.g., another SPST relay) is coupled between the AC input and the output. The UPS further includes a control circuit operative to control the first and second mechanical relays to selectively place the UPS in an on-line mode in which the first mechanical relay couples the AC/AC converter circuit to the output and the second mechanical relay decouples the AC input from the output or a bypass mode in which the first mechanical relay decouples the AC/AC converter circuit from the output and the second mechanical relay couples the AC input to the output.

According further embodiments of the invention, the control circuit is operative to place the UPS in the bypass mode by closing the second mechanical relay while maintaining the first mechanical relay in a closed state and then opening the first mechanical relay a predetermined time thereafter. The control circuit may be further operative to place the UPS in the on-line mode by closing the first mechanical relay while maintaining the second mechanical relay in a closed state and then opening the second mechanical relay a predetermined time thereafter. According to further aspects, the control circuit is operative to operate at least one of the first and second mechanical relays as a hypervelocity mechanical relay, for example, by applying a relatively high coil voltage to speed operation of the relay, followed by a reduced coil voltage that maintains the relay in its new state. In this manner, performance approaching that provided by bypass circuits employing solid state switches can be achieved.

According to various embodiments of the invention, relatively smooth transitions between on-line and bypass modes in an on-line UPS can be provided without requiring the use of solid state switches. Accordingly, the need for back-feed and/or fail-safe circuitry can be obviated, potentially reducing the complexity and/or cost of the UPS. The invention may be embodied as apparatus and methods.

### BRIEF DESCRIPTION OF THE DRAWINGS

FIG. 1 is a schematic diagram illustrating a conventional uninterruptible power supply (UPS).

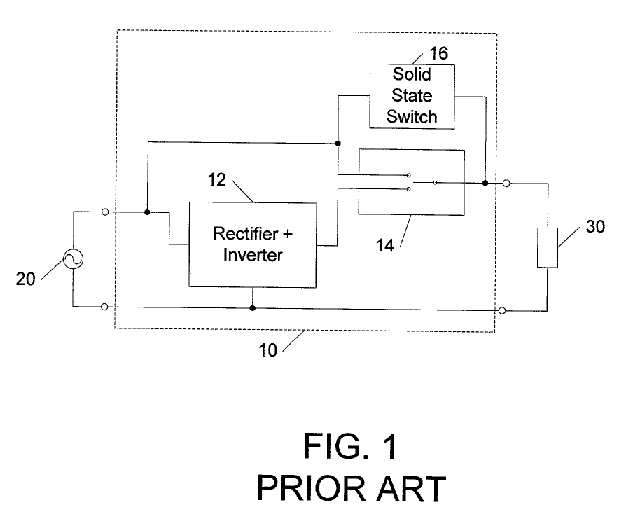

FIG. 2 is a schematic diagram illustrating a UPS according to some embodiments of the invention.

FIG. 3 is a schematic diagram illustrating a UPS according to further embodiments of the invention.

FIG. 4 is a waveform diagram illustrating exemplary operations of the UPS of FIG. 3.

### DETAILED DESCRIPTION

The present invention now will be described more fully with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

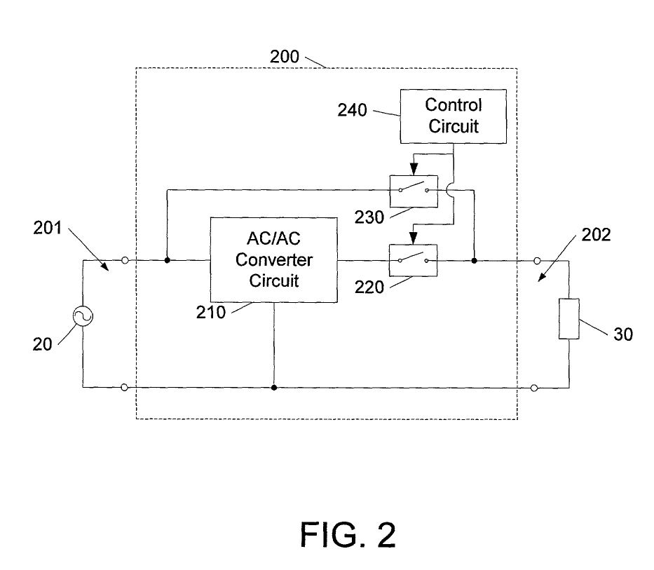

FIG. 2 illustrates an uninterruptible power supply (UPS) 200 according to some embodiments of the invention. The UPS 200 includes an AC input 201 configured to be coupled to an AC power source 20 (e.g., an AC utility line) and an output 202 configured to be coupled to a load 30. An AC/AC converter circuit 210 is coupled to the input 201. A first mechanical relay, here shown as a single-pole single-throw (SPST) relay 220, is operative to couple and decouple an output of the AC/AC converter circuit 210 to and from the output 202. A second mechanical relay 230 is operative to couple and decouple the AC input 201 to and from the output 202. A control circuit 240, e.g., a relay driver circuit, controls the first and second mechanical relays 220, 230.

Several advantages can be provided by the configuration of FIG. 2. In particular, the use of mechanical relays 220, 230 instead of a combination of a form C relay and a solid state switch can obviate the need to provide additional circuitry to prevent back-feed and provide fail-safe operation in compliance with regulatory requirements. Because the two relays 220, 230 can be operated in a “make before break” fashion, smooth transition between on-line and bypass modes can be achieved.

It will be appreciated that the components of the UPS 200, such as the control circuit 240, may, in general, be implemented using discrete circuitry, integrated circuits, data processing circuits configured to execute software and/or firmware, and combinations thereof. For example, the control circuit 240 may include a microprocessor, microcontroller or other data processing circuit in combination with discrete relay driving circuitry, such as transistors and logic circuit elements. It will be further understood that all or some of such circuitry may be integrated in one or more devices, such as application specific integrated circuits (ASICs) or hybrid circuits.

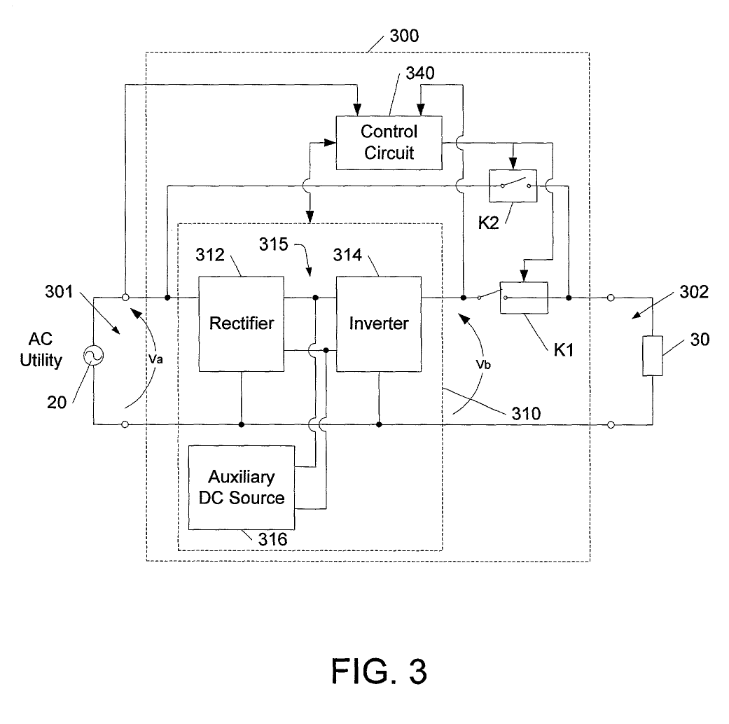

As shown in FIG. 3, a UPS 300 according to further embodiments of the invention includes an AC/AC converter circuit 310, first and second mechanical SPST relays K1, K2, and a control circuit 340. The AC/AC converter circuit 310 includes an input rectifier 312 that is coupled to an AC input 301 of the UPS 300 at which an AC power source 20 is connected. The AC/AC converter circuit 310 also includes an output inverter 314 coupled to the rectifier 312 by an intermediate DC bus 315. The AC/AC converter circuit 310 further includes an auxiliary DC power source 316 (e.g., a combination of a battery and a DC/DC converter) connected to the DC bus 315. The first mechanical SPST relay K1 is operative to couple and decouple the inverter 314 to and from an output 302 of the UPS 300 at which a load 30 is connected. The second mechanical SPST relay K2 is operative to couple and decouple the AC input 301 to and from the output 302. The control circuit 340 controls the mechanical SPST relays K1, K2, and the operation of the AC/AC converter circuit 310.

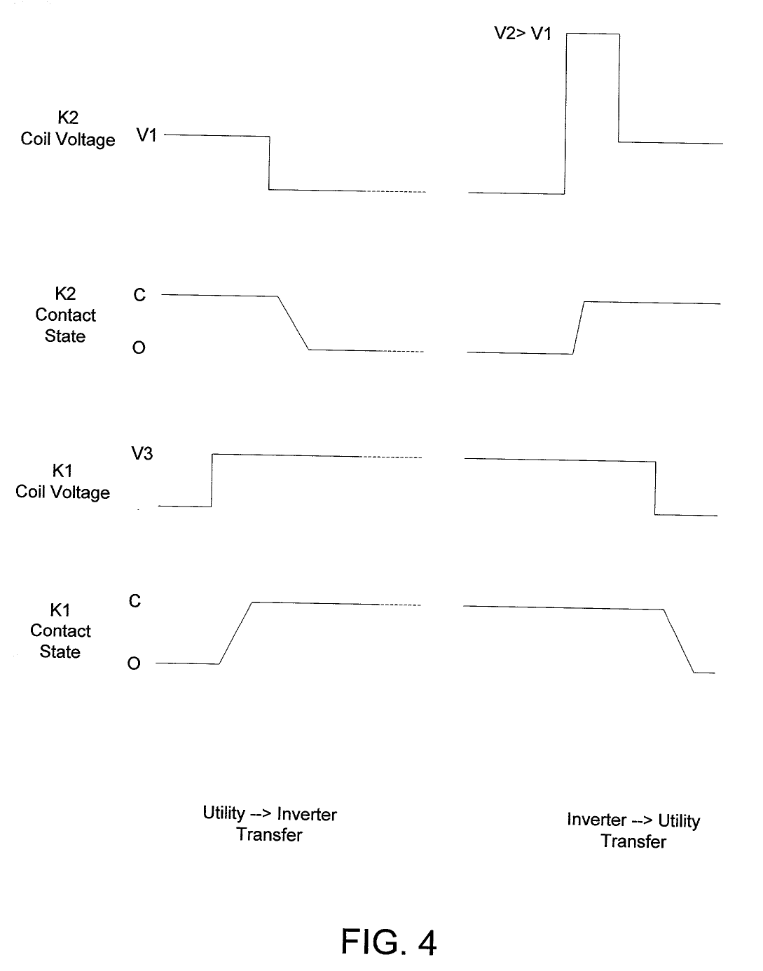

Exemplary operations for the UPS 300 of FIG. 3 are illustrated in FIG. 4. Initially, the UPS is in a bypass mode, i.e., a zero voltage is applied to the coil of the first relay K1 to maintain its contacts in an open state O, while a voltage V1 is applied to the coil of the second relay K2 to maintain its contacts in a closed state C. In order to transfer the load 30 from the AC power source 20 to the inverter 314, such that the UPS 300 operated in an “on-line” mode, the control circuit 340 first drives the coil of the first relay K1 with a voltage V3 sufficient to cause the contacts of the first relay K1 to begin a transition from an open state O to a closed state C. Following transition of the contacts of the first relay K1 to the closed state C, the control circuit 340 then applies a zero voltage to the coil of the second relay K2 to transition the contacts of the second relay K2 from a closed state C to an open state O.

In order to transfer the load 30 back to the AC power source 20 to place the UPS 300 in a “bypass” mode, the control circuit 340 applies a voltage V2 to the coil of the second relay K2 to transition its contacts from an open state O to a closed state C. After transition of the contacts of the second relay K2 to the closed state C, the control circuit 340 applies a zero voltage to the coil of the first relay K1 to transition its contacts from a closed state C to an open state O. As shown, the second relay K2 may be a “hypervelocity” relay, e.g., the control circuit 340 may apply a relatively high voltage V2 to transition the second relay K2 to the closed state C, followed by a lower voltage V1 that maintains the relay K2 in the closed state. In this manner, performance approaching conventional designs using solid state switches may be achieved in many fault scenarios. It is believed that such operation can result in at least 50% faster operation over use of a nominal coil voltage.

The coil current in a typical DC relay builds up slowly. In particular, after a voltage is applied to the coil, the shape of the coil current is similar to current that builds up in an inductance, except that motion of the relay's armature typically changes the inductance of the relay and, thus, affects the usual time-current relationship. When the armature “seats,” the coil current typically exhibits a dip, after which the coil current increases based on the inductance of the closed relay until it reaches a steady state value dominated by the resistance of the coil.

The application of a higher than rated coil voltage generally changes the way in which current builds up in the coil. Because of the higher voltage applied to the coil, coil current sufficient to start the armature moving typically occurs earlier than with a normal coil voltage applied. The more rapidly increasing coil current can increase the force applied to the armature, which can reduce the time to first strike (and can increase contact bounce, which may not be a problem in the bypass mode operation of a UPS). Upon closure of the contacts, the applied voltage can be reduced to a level that maintains the contacts in the closed position.

Circuits for providing such multi-level drive are known to those skilled in the art, and will not be discussed in greater detail herein. For example, relay manufacturers have used this principal on some large DC contactors. Such contactors typically have a coil that has a low inductance and DC resistance and that is capable of moving the armature rapidly, but that cannot continuously sustain the magnitude of coil current required to close the contacts. After the contacts have switched state, such contactors may reduce the current in the coil using an external series resistor that is switched in to lower the coil current to a level that will maintain the contacts in the closed position by effectively reducing voltage across the coil. It will be appreciated that these and other techniques for producing hypervelocity relay operation may be used with the present invention.

It will also be appreciated that the first relay K1 may also be a hypervelocity relay, and may be operated in a manner similar to the second relay K2 in transitioning the UPS 300 to the “on-line” mode. However, rapid operation of the second relay K2 may be more desirable. Accordingly, the first relay K1 may be operated as a “standard” relay, e.g., without such a two-level drive, which may entail simpler, lower cost drive circuitry.

Referring back to FIG. 3, the control circuit 340 may be operatively associated with the AC/AC converter circuit 310. For example, the control circuit 340 may be operative to sense an operating state of the AC/AC converter circuit 310, e.g., loading, output voltage or the like, and may operate the relays K1, K2 responsively thereto. It will be further appreciated that during times that the relays K1, K2 are both in a closed state, such that the inverter 314 and the AC power source 20 are both connected to the load 30, the control circuit 340 may be operative to synchronize operation of the AC/AC converter circuit 310 to the AC power source 20 such that backflow into the inverter 314 and other undesirable phenomena arising from lack of synchronization can be reduced.

For example, as shown in FIG. 3, the control circuit 340 may be responsive to an output voltage Va produced by the AC power source 20 and an output voltage Vb produced by the inverter 314. The control circuit 340 may, for example, adjust the frequency of operation of the inverter 314 responsive to a detected phase difference between the output voltage Va of the AC power source 20 and the output voltage Vb of the inverter 314 and adjust the amplitude of the output voltage Vb produced by the inverter 314 responsive to a detected amplitude difference between the output voltage Va of the AC power source 20 and the output voltage Vb of the inverter 314. For example, if the output voltage Vb of the inverter 314 is lagging the output voltage Va of the AC power source 20, the control circuit 340 may increase the frequency of operation of the inverter 314 to reduce phase error before transferring the load 30 to the inverter 314. Conversely, if the output voltage Vb of the inverter 314 is leading the output voltage Va of the AC power source 20, the control circuit 340 may responsively reduce the frequency of operation of the inverter 314 to reduce phase error before the transfer. Similarly, the amplitude of the output voltage Vb of the inverter 314 can be adjusted, e.g., by adjusting the DC voltage on the DC link 315, to substantially match the amplitude of the output voltage Va of the AC power source before transfer of the load 30 from the AC power source 20 to the inverter 314. Following transition of the load to the inverter 314, the frequency and/or amplitude of the output voltage Vb produced by the inverter 314 can be controlled independently of the output voltage Va produced by the AC power source 20.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. An on-line uninterruptible power supply (UPS) comprising:
an AC input configured to be coupled to an AC power source;
an output configured to be coupled to a load;
an AC/AC converter circuit coupled to the AC input and operative generate an AC voltage from the AC power source;
a first mechanical relay coupled between the AC/AC converter circuit and the output;
a second mechanical relay coupled between the AC input and the output; and
a control circuit operative to control the first and second mechanical relays to selectively place the UPS in an on-line mode in which the first mechanical relay couples the AC/AC converter circuit to the output and the second mechanical relay decouples the AC input from the output or a bypass mode in which the first mechanical relay decouples the AC/AC converter circuit from the output and the second mechanical relay couples the AC input to the output.

2. A UPS according to claim 1, wherein at least one of the first and second mechanical relays comprises a single-pole single-throw (SPST) relay.

3. A UPS according to claim 1, wherein the control circuit is operative to place the UPS in the bypass mode by closing the second mechanical relay while maintaining the first mechanical relay in a closed state and then opening the first mechanical relay a predetermined time thereafter.

4 A UPS according to claim 1, wherein the control circuit is operative to place the UPS in the on-line mode by closing the first mechanical relay while maintaining the second mechanical relay in a closed state and then opening the second mechanical relay a predetermined time thereafter.

5. A UPS according to claim 1, wherein the control circuit is operative to operate at least one of the first and second mechanical relays as a hypervelocity mechanical relay.

6. A UPS according to claim 5, wherein only the second mechanical relay is operated as a hypervelocity mechanical relay.

7. A UPS according to claim 5, wherein the control circuit is operative to apply a first nonzero voltage to a coil of the one of the first and second mechanical relays to cause transition of the one of the first and second mechanical relays from a first state to a second state and to apply a second voltage nonzero voltage less than the first non-zero voltage to the coil to maintain the one of the first and second mechanical relays in the second state.

8. A UPS according to claim 5, wherein the control circuit is operative to apply respective voltages to coils of respective ones of the first and second mechanical relays when transitioning contacts of the first and second mechanical relays such that the contacts of the second mechanical relay transition at least 50% faster than the contacts of the first mechanical relay.

9. A UPS according to claim 1, wherein the control circuit operates the first and second mechanical relays responsive to a state of the AC/AC converter circuit.

10. A UPS according to claim 1, wherein the AC/AC converter circuit comprises a series combination of a rectifier and an inverter.

11. A UPS according to claim 1, wherein the control circuit is further operative to control the AC/AC converter circuit.

12. A method of operating an on-line uninterruptible power supply (UPS), the method comprising:
providing a first mechanical relay coupled between an output of an AC/AC converter circuit of the UPS and an output of the UPS;
providing a second mechanical relay coupled between an AC input of the UPS and the output;
operating the first and second mechanical relays to place the UPS in an on-line mode in which the first mechanical relay couples the AC/AC converter circuit to the output and the second mechanical relay decouples the AC input from the output; and
operating the first and second mechanical relays to place the UPS in a bypass mode in which the first mechanical relay decouples the AC/AC converter circuit from the output and the second mechanical relay couples the AC input to the output.

13. A method according to claim 12, wherein at least one of the first and second mechanical relays comprises a single-pole, single-throw (SPST) relay.

14. A method according to claim 11, wherein operating the first and second mechanical relays to place the UPS in a bypass mode comprises:
closing the second mechanical relay while maintaining the first mechanical relay in a closed state; and then
opening the first mechanical relay a predetermined time thereafter.

15. A method according to claim 14, wherein closing the second mechanical relay comprises operating the second mechanical relay as a hypervelocity mechanical relay.

16. A method according to claim 15, wherein the first mechanical relay is not operated as a hypervelocity mechanical relay.

17. A method according to claim 15, wherein operating the second mechanical relay as a hypervelocity mechanical relay comprises:
applying a first nonzero voltage to a coil of the second mechanical relay to cause transition of the second mechanical relay from a first state to a second state; and
applying a second voltage nonzero voltage less than the first non-zero voltage to the coil to maintain the second mechanical relay in the second state.

18. A method according to claim 15, wherein operating the second mechanical relay as a hypervelocity relay comprises driving contacts of the second mechanical relay at least 50% faster than contacts of the first mechanical relay.

19. A method according to claim 12, wherein operating the first and second mechanical relays to place the UPS in an on-line mode comprises:
closing the first mechanical relay while maintaining the second mechanical relay in a closed state; and then
opening the second mechanical relay a predetermined time thereafter.

20. A method according to claim 19, wherein closing the first mechanical relay comprises operating the first mechanical relay as a hypervelocity mechanical relay.

21. A method according to claim 12, further comprising operating the first and second mechanical relays responsive to a state of the AC/AC converter circuit.

22. A method according to claim 12, wherein the AC/AC converter circuit comprises a series combination of a rectifier and an inverter.
